(19) United States
(12) Patent Application Publication
(10) Pub. No.: US 2004/0208509 A1
(43) Pub. Date: Oct. 21, 2004

(54) Upgradeable photonic networking apparatus and method

(76) Inventors: Ornan A. Gerstel, Los Altos, CA (US); Rajiv Ramaswami, Sunnyvale, CA (US)

Correspondence Address: BROMBERG & SUNSTEIN LLP, 125 SUMMER STREET, BOSTON, MA, 02110-1618, US

(21) Appl. No.: 10/259,238

(22) Filed: Sep. 27, 2002

Related U.S. Application Data
(60) Provisional application No. 60/368,275, filed on Mar. 27, 2002.

(51) Int. Cl. H04B 10/08; H04B 10/20; H04J 14/00

(52) U.S. Cl. 398/19

(57) ABSTRACT

An upgradeable photonic networking apparatus and method uses components in the upgradeable photonic networking apparatus to establish a number of alternate optical paths around an upgradeable element. The upgradeable element can be replaced with a new element introduced into the number of alternate optical paths, or else the upgradeable element can be upgraded after which optical paths are restored through the upgradeable element.

### PRIORITY

The present application claims priority from U.S. Provisional Patent Application No. 60/368,275 filed on Mar. 27, 2002, which is hereby incorporated herein by reference in its entirety.

### FIELD OF THE INVENTION

The present invention relates generally to optical networking, and more particularly to an upgradeable photonic networking apparatus and method.

### BACKGROUND OF THE INVENTION

Optical networks carry information in the form of light over optical fibers. Various forms of wavelength division multiplexing (WDM) can be used to carry multiple optical signal channels over a single optical fiber, specifically by conveying each optical signal channel using a different optical wavelength. Optical signals can be switched using various types of networking devices, such as optical add/drop multiplexers, optical cross-connect switches, and routers.

Nodes in optical networks can be generally categorized as being either opaque or photonic. An opaque node is one in which optical signals are converted into electronic information for processing in the electrical domain. A photonic node is one in which optical signals are processed in the optical domain.

One problem in photonic nodes is upgrading of node elements. Normally, photonic node upgrades are complicated processes that can take several hours to days to complete, and tend to disrupt traffic flowing through the photonic node.

### SUMMARY OF THE INVENTION

In accordance with one aspect of the invention, an upgradeable photonic networking apparatus includes a number of input side devices, a number of output side devices, and an upgradeable element coupled between the number of input side devices and the number of output side devices. The input side devices and the output side devices are configurable for providing a number of primary optical paths through the upgradeable element and for providing a number of alternate optical paths around the upgradeable element for upgrading the upgradeable element. The number of input side devices may include an optical switch that is configurable for providing at least one of an optical path through the upgradeable element and an alternate optical path around the upgradeable element. The number of input side devices may include an optical splitter operably coupled to provide a primary optical path through the upgradeable element and to provide an alternate optical path around the upgradeable element. The number of output side devices typically include an optical switch that is configurable for selecting one of a primary optical path through the upgradeable element and an alternate optical path around the upgradeable element. The upgradeable element may be an optical amplifier, a photonic patch panel, or a photonic switching fabric, to name but a few.

In accordance with another aspect of the invention, a method for upgrading an upgradeable photonic networking apparatus involves introducing a new element into the upgradeable photonic networking apparatus and configuring a number of input side devices and a number of output side devices to provide a number of alternate optical paths around the upgradeable element through the new element. The number of input side devices may include an optical switch that is configurable for providing at least one of an optical path through the upgradeable element and an alternate optical path around the upgradeable element. The number of input side devices may include an optical splitter operably coupled to provide a primary optical path through the upgradeable element and to provide an alternate optical path around the upgradeable element. The number of output side devices typically include an optical switch that is configurable for selecting one of a primary optical path through the upgradeable element and an alternate optical path around the upgradeable element. The upgradeable element may be an optical amplifier, a photonic patch panel, or a photonic switching fabric, to name but a few. Once the new element is inserted and the number of alternate optical paths around the upgradeable element are established, the upgradeable element can be removed, or alternatively the upgradeable element can be upgraded after which the input side devices and the output side devices can be configured to provide a number of primary optical paths through the upgradeable element after upgrading the upgradeable element.

In accordance with another aspect of the invention, an upgradeable photonic networking apparatus includes an upgradeable element and

means for bypassing the upgradeable element for upgrading the upgradeable element without substantially disrupting traffic flow through the upgradeable photonic networking apparatus. The means for bypassing the upgradeable element may include means for inserting a new element into a number of alternate optical paths around the upgradeable element, and may also include means for configuring the new element for providing connectivity for the number of alternate optical paths around the upgradeable element.

### BRIEF DESCRIPTION OF THE DRAWINGS

In the accompanying drawings:

FIG. 1 shows an exemplary photonic node including an upgradeable element situated between an input side switch and an output side switch in accordance with an embodiment of the present invention;

FIG. 2 shows the photonic node of FIG. 1 with a new element introduced into the alternate optical path;

FIG. 3 shows the photonic node of FIG. 2 with the output side switch configured to select the alternate optical path through the new element;

FIG. 4 shows an exemplary photonic node including an upgradeable element situated between an input side splitter and an output side switch in accordance with another embodiment of the present invention;

FIG. 5 shows an exemplary photonic node in which the upgradeable element is an optical amplifier;

FIG. 6 shows an exemplary photonic add/drop node in which the upgradeable element is a patch panel that can be replaced with a photonic switch fabric;

FIG. 7 shows an exemplary photonic switch of FIG. 6 in which the patch panel is replaced by a photonic switch fabric; and

FIG. 8 shows potential locations within a photonic add/drop node for placing the input side switches/splitters and the output side switches.

### DETAILED DESCRIPTION OF A PREFERRED EMBODIMENT

In an embodiment of the present invention, a photonic node includes various elements that enable upgrades to be performed quickly with little or not disruption to the traffic flow. The terms “upgrade” and “upgradeable” are used herein to mean that an element of the photonic node can be removed, replaced, repaired, calibrated, maintained, or otherwise manipulated in any way, and should not be construed to limit the present invention to any particular type of element or to any particular type of upgrade.

Specifically, a photonic node includes an upgradeable element situated between at least one optical switch or splitter on the input side of the upgradeable element and at least one optical switch on the output side of the upgradeable element. Each input side switch or splitter is capable of providing a primary optical path to an output side switch through the upgradeable element and an alternate optical path to an output side switch that bypasses the upgradeable element. Each output side switch is configurable to select as its input a primary optical path through the upgradeable element or an alternate optical path that bypasses the upgradeable element.

In order to upgrade the upgradeable element, a new element is introduced into the alternate optical path(s). If necessary, each input side switch or splitter is configured to provide an alternate optical path to an output side switch through the new element. Each output side switch is configured to select an alternate optical path through the new element. If necessary, the new element is configured to provide the correct connectivity from the input side switch(es) or splitter(s) to the output side switch(es).

With the alternate optical paths established around the upgradeable element, the upgradeable element can then be upgraded. If the new element is a permanent replacement for the upgradeable element, then the upgradeable element can be removed from the photonic switch if desired. If the new element is just a temporary replacement for the upgradeable element, for example, while the upgradeable element is being repaired, calibrated, or maintained, then the upgradeable element can be put back into service by re-establishing the primary optical path(s) through the upgradeable element. This may involve re-configuring the input side switch(es) or splitter(s) to provide the primary optical path(s) through the upgradeable element and/or configuring the output side switch(es) to select the primary optical path(s) after the upgrade is complete, at which time the new element can be removed.

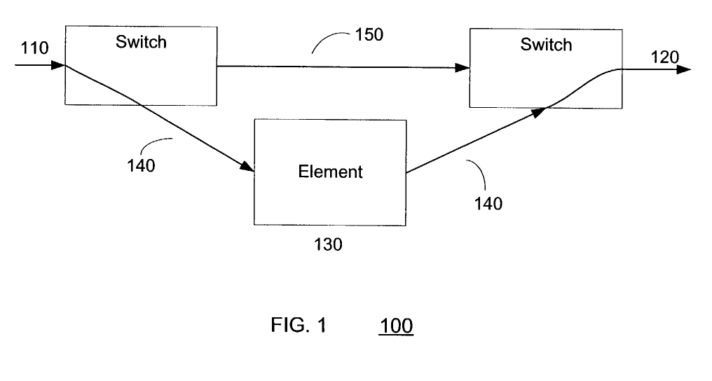

FIG. 1 shows an exemplary photonic node 100 in accordance with an embodiment of the present invention. Among other things, the photonic node 100 includes an input side switch 110, an output side switch 120, and an upgradeable element 130. The input side switch 110 can be configured to provide a primary optical path 140 to the output side switch 120 through the upgradeable element 130 and/or an alternate optical path 150 to the output side switch 120 that bypasses the upgradeable element 130. The output side switch 120 can be configured to select the primary optical path 140 or the alternate optical path 150. FIG. 1 shows the output side switch 120 configured to select the primary optical path 140.

In order to upgrade the upgradeable element 130, a new element is first introduced into the alternate optical path 150.

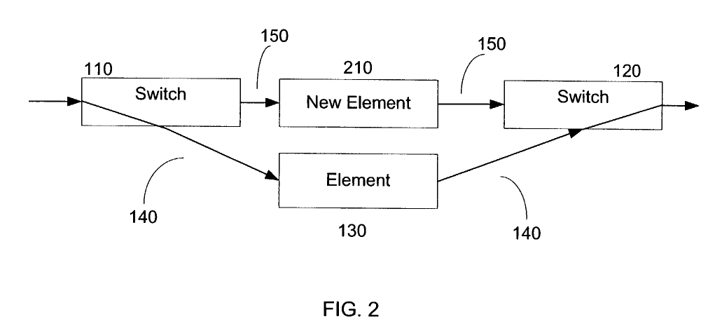

FIG. 2 shows the photonic node of FIG. 1 with a new element 210 introduced into the alternate path 150. At this point, the output side switch 120 is still configured to select the primary optical path 140.

Once the new element 210 is introduced into the alternate optical path 150, the output side switch 120 is configured to select the alternate optical path 150 through the new element in order to bypass the upgradeable element 130.

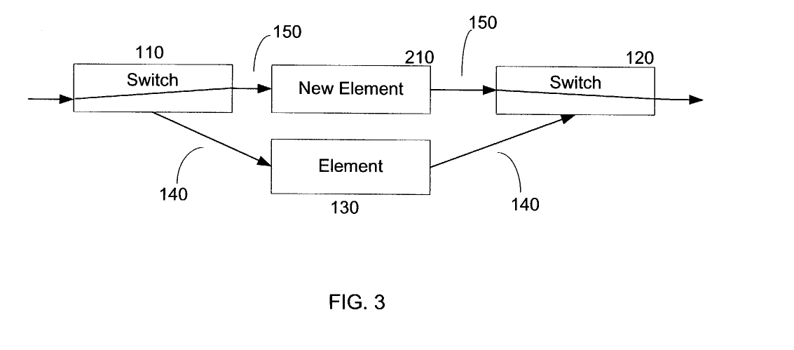

FIG. 3 shows the photonic node of FIG. 2 with the output side switch 120 configured to select the alternate optical path 150 through the new element 210.

Once the output side switch 120 is configured to select the alternate optical path 150 through the new element, the upgradeable element 130 can be removed from the photonic switch 100.

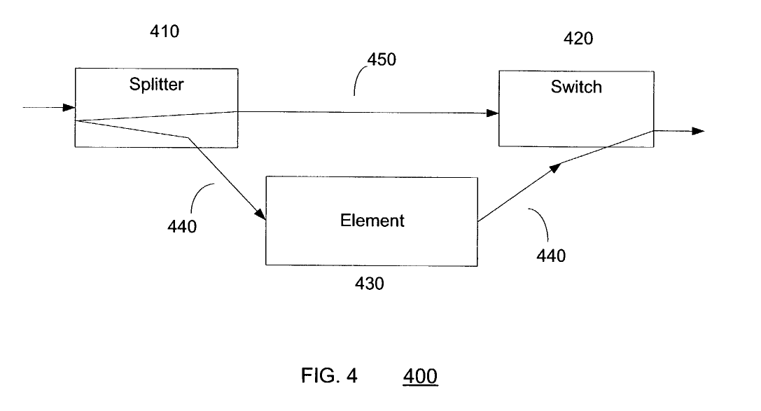

FIG. 4 shows an exemplary photonic node 400 in accordance with another embodiment of the present invention. Among other things, the photonic node 400 includes an input side splitter 410, an output side switch 420, and an upgradeable element 430. The input side splitter 410 simultaneously provides a primary optical path 440 to the output side switch 420 through the upgradeable element 430 and an alternate optical path 450 to the output side switch 420 that bypasses the upgradeable element 430. The output side switch 420 can be configured to select the primary optical path 440 or the alternate optical path 450. FIG. 4 shows the output side switch 420 configured to select the primary optical path 440.

As before, in order to upgrade the upgradeable element 430, a new element is introduced into the alternate optical path 450, and the output side switch 430 is configured to select the alternate optical path 450. The upgradeable element 430 can then be removed from the photonic node 400.

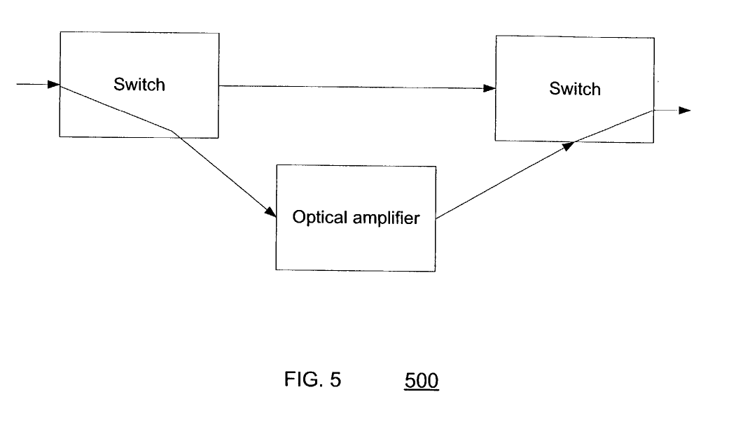

FIG. 5 shows an exemplary photonic node 500 in which the upgradeable element is an optical amplifier.

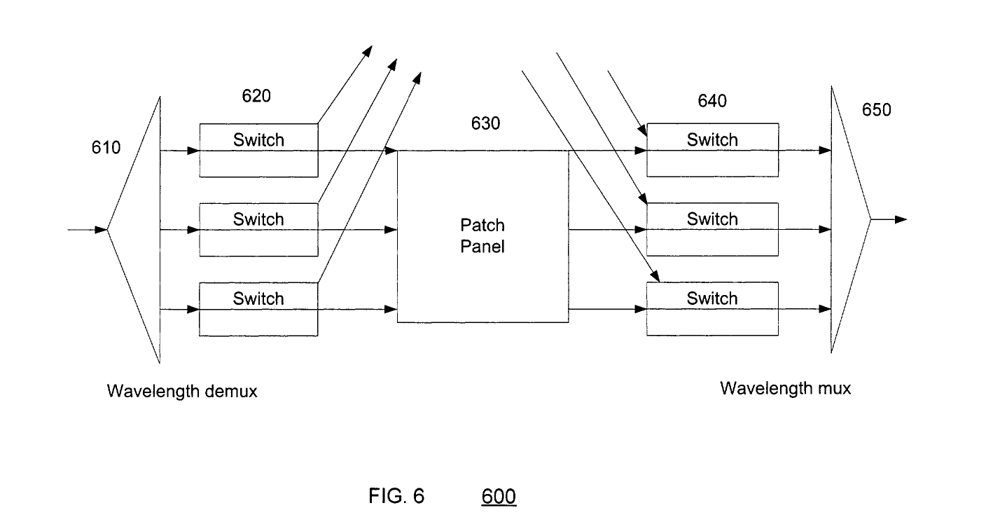

FIG. 6 shows an exemplary photonic add/drop node 600 in which the upgradeable element is a patch panel that can be replaced with a photonic switch fabric. Among other things, the photonic add/drop node 600 includes a wavelength demultiplexer 610, a patch panel 630, and a wavelength multiplexer 650. Optical switches (or splitters) 620 are placed on the input side of the patch panel 630 between the wavelength demultiplexer 610 and the patch panel 630, and optical switches 640 are placed on the output side of the patch panel 630 between the patch panel 630 and the wavelength multiplexer 650. Each input side switch (or splitter) 620 can be configured to provide a primary optical path through the patch panel 630 and/or an alternate optical path bypassing the patch panel 630. Each output side switch 640 can be configured to select a primary optical path from the patch panel 630 or an alternate optical path bypassing the patch panel 630. FIG. 6 shows the output side switches 640 configured to select the primary optical paths.

In order to replace the patch panel 630 with a photonic switch fabric, the photonic switch fabric is connected to the alternate paths from the input side switches 620 to the output side switches 640, and then the output side switches 640 are configured to select the alternate optical paths.

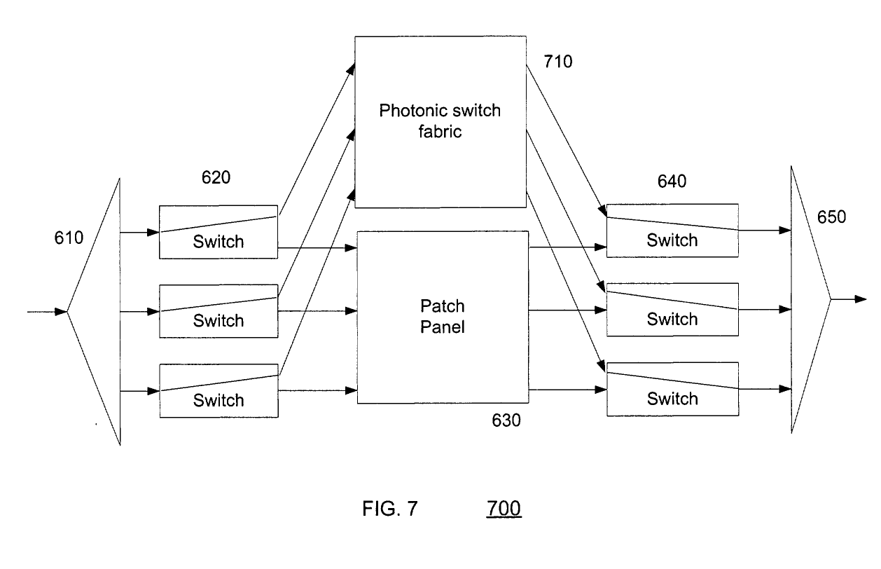

FIG. 7 shows an exemplary photonic switch 700 in which the patch panel 630 is replaced by a photonic switch fabric 710. FIG. 7 shows the output side switches 640 configured to select the alternate optical paths through the photonic switch fabric 710.

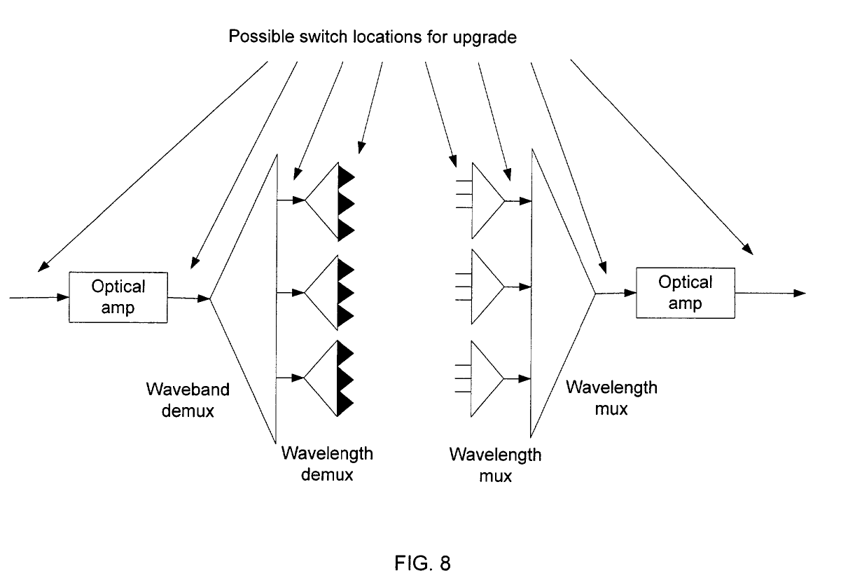

FIG. 8 shows other potential locations within a photonic add/drop node for placing the input side switches/splitters and the output side switches. For example, the switches can be placed around the entire node, or between the input optical amplifier and the output amplifier, or between different stages of demultiplexing.

A desirable feature for an upgradeable photonic add/drop node is the ability of the network to automatically discover the connectivity within the node. For example, when a connection is made, either using the patch panel or the photonic switch fabric, the network should automatically discover this connection. This can be done using a variety of techniques. In one exemplary technique, a smart cable that incorporates an electronic identifier tag is used to make the connections. At the ends of the cable, the connectors read the identifier from this tag and the network management system (not shown) can then determine the local connectivity.

In the photonic add/drop node 700, once the node has been upgraded to include the photonic switch fabric 710, it is desirable to have the connectivity within the node the same as it was before the upgrade. This can be done, for example, by using the connectivity information present initially to configure the photonic switch fabric 710 to replicate the connectivity.

It should be noted that the input side switch(es)/splitter(s) and the output side switch(es) are not required to be directly connected to the upgradeable element. Furthermore, the input side switch(es)/splitter(s) and the output side switch(es) can surround multiple upgradeable elements, and one of which can be upgraded as described above.

The present invention may be embodied in other specific forms without departing from the true scope of the invention. The described embodiments are to be considered in all respects only as illustrative and not restrictive.

What is claimed is:

1. An upgradeable photonic networking apparatus comprising:
a number of input side devices;
a number of output side devices; and
an upgradeable element coupled between the number of input side devices and the number of output side devices, wherein the input side devices and the output side devices are configurable for providing a number of primary optical paths through the upgradeable element and for providing a number of alternate optical paths around the upgradeable element for upgrading the upgradeable element.

2. The upgradeable photonic networking apparatus of claim 1, wherein the number of input side devices comprises:
at least one optical switch that is configurable for providing at least one of an optical path through the upgradeable element and an alternate optical path around the upgradeable element.

3. The upgradeable photonic networking apparatus of claim 1, wherein the number of input side devices comprises:
at least one optical splitter operably coupled to provide a primary optical path through the upgradeable element and to provide an alternate optical path around the upgradeable element.

4. The upgradeable photonic networking apparatus of claim 1, wherein the number of output side devices comprises:
at least one optical switch that is configurable for selecting one of a primary optical path through the upgradeable element and an alternate optical path around the upgradeable element.

5. The upgradeable photonic networking apparatus of claim 1, wherein the upgradeable element comprises an optical amplifier.

6. The upgradeable photonic networking apparatus of claim 1, wherein the upgradeable element comprises a photonic patch panel.

7. The upgradeable photonic networking apparatus of claim 1, wherein the upgradeable element comprises a photonic switching fabric.

8. A method for upgrading an upgradeable photonic networking apparatus, the upgradeable photonic networking apparatus comprising an upgradeable element coupled between a number of input side device and a number of output side devices, the input side devices and the output side devices configurable for providing a number of primary optical paths through the upgradeable element and for providing a number of alternate optical paths around the upgradeable element, the method comprising:
introducing a new element into the upgradeable photonic networking apparatus; and
configuring the input side devices and the output side devices to provide the number of alternate optical paths around the upgradeable element through the new element.

9. The method of claim 8, wherein the number of input side devices comprises:
at least one optical switch that is configurable for providing at least one of an optical path through the upgradeable element and an alternate optical path around the upgradeable element.

10. The method of claim 8, wherein the number of input side devices comprises:
at least one optical splitter operably coupled to provide a primary optical path through the upgradeable element and to provide an alternate optical path around the upgradeable element.

11. The method of claim 8, wherein the number of output side devices comprises:
at least one optical switch that is configurable for selecting one of a primary optical path through the upgradeable element and an alternate optical path around the upgradeable element.

12. The method of claim 8, further comprising:
removing the upgradeable element from the upgradeable photonic networking apparatus.

13. The method of claim 8, further comprising:
upgrading the upgradeable element while the input side devices and the output side devices are configured to provide the number of alternate optical paths around the upgradeable element; and
configuring the input side devices and the output side devices to provide the number of primary optical paths through the upgradeable element after upgrading the upgradeable element.

14. The method of claim 8, further comprising:
configuring the new element for providing connectivity from the number of input side devices to the number of output side devices through the new element.

15. The method of claim 8, wherein the upgradeable element comprises an optical amplifier.

16. The method of claim 8, wherein the upgradeable element comprises a photonic patch panel.

17. The method of claim 8, wherein the upgradeable element comprises a photonic switching fabric.

18. An upgradeable photonic networking apparatus comprising:
an upgradeable element; and
means for bypassing the upgradeable element for upgrading the upgradeable element without substantially disrupting traffic flow through the upgradeable photonic networking apparatus.

19. The upgradeable photonic networking apparatus of claim 18, wherein the means for bypassing the upgradeable element comprises:
means for inserting a new element into a number of alternate optical paths around the upgradeable element.

20. The upgradeable photonic networking apparatus of claim 19, wherein the means for bypassing the upgradeable element further comprises:
means for configuring the new element for providing connectivity for the number of alternate optical paths around the upgradeable element.
